(19) United States
(12) Patent Application Publication
(10) Pub. No.: US 2026/0266616 A1
(43) Pub. Date: Sep. 10, 2026

(54) System for Fast and Efficient Navigation of Emergency Vehicles with Automated Traffic Warning

(71) Applicant: Kosta Oroz, Boezen (CH)

(72) Inventor: Kosta Oroz, Boezen (CH)

(21) Appl. No.: 19/553,369

(22) Filed: Mar. 1, 2026

(30) Foreign Application Priority Data
Mar. 10, 2025 (DE) DE202025101297.9

(51) Int. Cl. G01C 21/34; G01C 21/36; G08G 1/133

(52) U.S. Cl. CPC G01C 21/3492; G01C 21/36; G08G 1/133

(57) ABSTRACT

A system and method for optimizing navigation and traffic management for emergency vehicles, such as ambulances, police cars, and fire trucks. Upon receiving an emergency notification, the system determines the incident location and computes an optimal route using real-time traffic data, road conditions, construction sites, traffic light phases, lane widths, and speed regulations. The route is transmitted to the emergency vehicle. Simultaneously, targeted warnings are sent via low-latency communication technologies including V2X, V2V, V2I, 5G, Bluetooth, eSIM, and WLAN to road users on affected route segments, instructing them to form emergency lanes. Warnings include visual and acoustic alerts, with optional acknowledgment confirmation. The system adapts dynamically to changing conditions, supports integration into existing navigation platforms, and operates in urban and rural environments to minimize delays and enhance safety.

### CROSS-REFERENCE TO RELATED APPLICATIONS

This application claims the benefit of priority under 35 U.S.C. § 119(a)-(d) to German Utility Model Application No. [DE. 20 2025 101 297.9], filed on Mar. 11, 2025 with the German Patent and Trade Mark Office (DPMA).

### BACKGROUND

Conventional navigation systems for vehicles typically determine the shortest or fastest route using map data and basic real-time traffic information. However, these systems do not address the specific needs of emergency vehicles, which require priority passage with minimal delay. Existing solutions often depend on passive warnings, such as sirens and lights, or simple broadcast notifications to nearby vehicles. These approaches lack intelligent, targeted interaction and do not dynamically adjust to form emergency lanes precisely when and where they are needed.

Prior art approaches often fail to incorporate comprehensive real-time data sources, including road conditions, traffic light phases, lane widths, construction sites, speed limits, and V2X communications. Because of these limitations, emergency vehicles may face unnecessary delays, increased risk, and uncoordinated traffic maneuvers from other road users. Many existing systems are restricted to isolated functions, lack network-based coordination between dispatch centers, emergency vehicles, and surrounding traffic participants, and do not adapt dynamically to changing conditions. Additionally, some related patent applications or technologies are outdated, abandoned, or not sufficiently comprehensive.

Therefore, there is a need for an improved system that calculates optimal routes adapted to real-time conditions, selectively warns only relevant road users, facilitates coordinated emergency lane formation, and integrates seamlessly with existing navigation platforms.

### BRIEF SUMMARY OF THE INVENTION

The present invention provides a system and method for fast and efficient navigation of emergency vehicles, combined with automated, targeted traffic warnings. The system determines an optimal route for an emergency vehicle by integrating multiple real-time data sources and dynamically communicates targeted instructions to road users located on or near the calculated route.

Upon receipt of an emergency dispatch notification, the system identifies the incident location and computes an optimized route that considers not only distance and estimated time, but also current traffic flow, infrastructure constraints such as construction sites, lane widths, traffic light phases, and predicted bottlenecks. The route is transmitted to the emergency vehicle in real time. The system selectively transmits warnings (visual and/or acoustic) only to road users actually positioned on the affected route segments, using low-latency communication technologies such as V2X, V2V, V2I, 5G, Bluetooth, eSIM, and WLAN. This targeted approach prevents unnecessary notifications, reduces driver confusion, avoids premature or delayed maneuvers, and encourages timely formation of emergency lanes without causing additional congestion or hazards.

The system may also include a confirmation mechanism so warned road users acknowledge receipt of the instruction, allowing verification of compliance and further adaptation if needed. The invention can be implemented as a standalone software application, a modular add-on for existing navigation platforms, or integrated into dispatch center systems. It supports operation in urban and rural environments and maintains functionality even with varying network coverage. The system improves emergency response times, enhances road safety, and provides a scalable, economically viable solution compatible with current and future communication standards.

### DETAILED DESCRIPTION AND BEST MODE OF IMPLEMENTATION

The invention uses an advanced combination of real-time traffic data, intelligent communication, and adaptive warning strategies to provide fast and efficient navigation for emergency vehicles. When an emergency notification is received, the system automatically determines the exact location of the incident and calculates the optimal route for the emergency vehicle, considering current traffic data. The calculated route is immediately transmitted to the emergency vehicle, enabling it to proceed along the best possible path without delay.

In parallel, the system actively communicates with road users located along the route. Warnings are targeted specifically at drivers present on the affected route section and are delivered visually (on navigation devices or mobile devices) and acoustically to ensure they are noticed. A confirmation function allows the system to verify that the warning has been acknowledged by the road user, reducing the risk of misinterpretation and ensuring timely reaction.

Communication between components occurs via a state-of-the-art network utilizing V2X, V2V, V2I, Bluetooth, eSIM, 5G, and WLAN technologies. This enables near real-time data transmission and ensures all relevant parties—from dispatch centers to emergency vehicles and ordinary road users—are interconnected in real time. The system adapts flexibly to different network infrastructures and maintains reliable functionality even in areas with limited mobile network coverage.

1. A system for real-time navigation optimization and targeted traffic management for emergency vehicles, comprising: a processor configured to receive an emergency notification including an incident location; access real-time data such as traffic density, road conditions, construction sites, traffic light phases, lane widths, and speed limits; compute an optimized route for an emergency vehicle that minimizes delays by integrating real-time data, prioritizing routes that avoid bottlenecks caused by construction sites or narrow lanes; transmit the optimized route to the emergency vehicle's navigation unit; identify road users located on specific segments of the optimized route; and a communication interface configured to selectively transmit targeted warning messages exclusively to identified road users using V2X, V2V, V2I, 5G, eSIM, Bluetooth, or WLAN protocols. The targeted warning messages include instructions to form an emergency lane and are transmitted only to road users requiring immediate action based on their position relative to the emergency vehicle. The system dynamically updates the optimized route and warning messages in response to changes in real-time data.
The system of claim 1, wherein the targeted warning messages comprise visual alerts displayed on navigation devices or mobile applications of the identified road users and acoustic alerts to ensure prompt attention.
The system of claim 1, wherein the processor is further configured to receive acknowledgment confirmations from identified road users confirming receipt or compliance with the targeted warning messages, and to reroute the emergency vehicle or resend warnings if acknowledgments are not received within a predefined threshold time.
The system of claim 1, wherein the communication interface adapts the transmission protocol based on available network coverage, prioritizing low-latency options such as 5G or V2X in urban areas and switching to Bluetooth or WLAN in rural areas with limited connectivity.
The system of claim 1, wherein the system is implemented as a modular software component that can be integrated into existing navigation platforms via an application programming interface (API), enabling scalability across dispatch centers and emergency fleets.
A computer-implemented method for providing efficient navigation and automated traffic warnings for emergency vehicles, comprising: receiving an emergency notification specifying an incident location; retrieving real-time infrastructure and traffic data including traffic flow, road conditions, construction sites, traffic light phases, lane widths, and speed regulations; calculating an optimized route for the emergency vehicle by processing real-time data to select a path that minimizes interruptions, with weighted consideration for construction sites and lane widths as potential delays; transmitting the optimized route to the emergency vehicle; determining a subset of road users positioned on or adjacent to segments of the optimized route; and selectively sending targeted instructions via low-latency communication technologies including V2X, V2V, V2I, 5G, eSIM, Bluetooth, or WLAN exclusively to the determined subset of road users. The targeted instructions direct formation of an emergency lane and are timed to avoid premature or delayed maneuvers that could cause congestion or hazards. The method further includes dynamically recalculating the optimized route and updating instructions upon detecting changes in real-time data.
The method of claim 6, wherein the targeted instructions are delivered as a combination of visual notifications on in-vehicle displays and acoustic signals to maximize driver awareness.
The method of claim 6, further comprising verifying compliance by receiving acknowledgment signals from road users and adjusting the route or instructions if compliance is insufficient.
The method of claim 6, wherein the low-latency communication technologies are selected adaptively based on environmental factors to ensure reliable operation in both urban and rural settings.
The method of claim 6, wherein the method is executed via a standalone application or as an integrated service within commercial navigation systems, supporting flexible deployment for various emergency services.
